(19) United States
(12) Patent Application Publication
(10) Pub. No.: US 2011/0126642 A1
(43) Pub. Date: Jun. 2, 2011

(54) Adapter for turning a steering wheel

(76) Inventor: Kurt STÄHLE, Neuhausen-Steinegg (DE)

(21) Appl. No.: 12/955,294

(22) Filed: Nov. 29, 2010

(30) Foreign Application Priority Data
Nov. 28, 2009 (DE) 10 2009 056 209.5

(51) Int. Cl. G01L 1/22

(52) U.S. Cl. 73/862.634; 73/862.621

(57) ABSTRACT

An actuator apparatus (10) for operation of at least one foot pedal (8) of a motor vehicle (4) has at least one operating element (12) that is drivable for pressure application to the foot pedal (8) by means of an actuator (14), and a force sensor (16), by means of which a pressure-application force that can be generated at a contact surface (20) of the operating element (12) can be detected. Provision is made in this arrangement that the contact surface (20) is formed by a pressure-application plate (18) and that the force sensor (16) is disposed on a side (22) of the pressure-application plate (18) facing away from the contact surface (20).

The invention relates to an actuator apparatus for operation of at least one foot pedal of a motor vehicle according to the preamble of claim 1. This actuator apparatus has at least one operating element for operation of at least one foot pedal of a motor vehicle. In this arrangement the operating element is drivable for pressure application to the foot pedal by means of an actuator. Further, the actuator apparatus has a force sensor, by means of which a pressure-application force that can be generated at a contact surface of the operating element can be determined or derived.

Such actuator apparatuses are required in order to carry out, for example, function and endurance tests of the foot pedals of a motor vehicle, such as the accelerator pedal, clutch pedal and brake pedal, or in order to drive the vehicle in an automated or semi-automated mode. This involves the actuator apparatus carrying out recurrent motion sequences for pressure application to the foot pedals that correspond as closely as possible to the actual operation of the foot pedals in the anticipated use of the vehicle.

From DE 24 15 095 A1 there is known an operating device for a brake pedal in which a brake pedal contact pad can be pressed against the particular pedal. The brake pedal contact pad is bearing-mounted for this purpose on a piston rod of an operating device by means of a ball joint. In order to determine during the operation an actual force transmitted to the brake pedal, a brake force detecting element is provided at the bottom of the brake pedal contact pad, which brake force detecting element is pressed together with the brake pedal contact pad against the particular pedal. Further, two micro switches are provided, by means of which a contact between the brake pedal contact pad and the pedal, as well as an end stop position of the pedal can be detected.

It is a shortcoming of the known actuator apparatus that the installation and alignment thereof in the particular vehicle is relatively complex since in particular the brake pedal contact pad and the plungers of the micro switches must be positioned very accurately with respect to the brake pedal and the footwell floor of the vehicle, in order to be able to ensure a trouble-free operation. Additionally, even with a precise pre-adjustment, malfunctions, in particular due to vibrations that arise in the operation, can occur that are caused for example by variable positions of the brake force detecting element relative to the pedal.

The aim of the invention is to prevent, in a generic actuator apparatus, the above-mentioned shortcomings and to provide for a simple installation and trouble-free operation.

This aim is achieved by an actuator apparatus having the features of claim 1. In this arrangement the contact surface is formed by a pressure-application plate and the force sensor is disposed on a side of the pressure-application plate facing away from the contact surface. The term pressure-application plate in this context can refer to any element that has on the contact surface side thereof a substantially flat surface extension that is equivalent in particular to at least the width of a commercial foot pedal. In this manner the force sensor records the compressive force created by the operating element not on the contact surface of the pressure-application plate but on the back thereof. If the pressure-application plate is designed appropriately stiff, like for example in a design in the form of a metal plate, one hereby achieves on one hand that the measured value recorded on the back is substantially identical to the compressive force generated at the contact surface, and this measured value is substantially independent, on the other hand, of the location on the contact surface at which the compressive force is actually generated in the operation. This makes it possible to ignore influences of, for example vibration-induced, position changes of the operating element with respect to the pedal on the measured values of the force sensor. Furthermore, it suffices in this actuator apparatus to arrange the operating element on the particular pedal in a manner so as to merely ensure a reliable pressure application to the pedal. Any additional requirements in positioning the operating device are not necessary, however, which significantly simplifies the installation of the actuator apparatus.

In a particularly advantageous embodiment the force sensor has a strain sensor on an elastic mechanical sensing element that is disposed between the pressure-application plate and the actuator. This permits a particularly precise determination of a compressive loading occurring on the pressure-application plate in the operation, by sensing a resulting change in length of the mechanical sensing element, such as a compression or strain.

In this arrangement it is advantageous when the mechanical sensing element has a cantilever beam or is formed by this cantilever beam. The cantilever beam in this arrangement can be formed of any known suitable elastic material, for example of a metal, such as in particular aluminum or steel, or of a plastic material, such as in particular a carbon-fiber reinforced plastic material. Such a cantilever beam, on one hand, permits the problem-free transmission of even relatively large compressive forces. On the other hand, the shape-related or material-related elasticity of same makes it possible to set a steady spring constant for the loading conditions anticipated to occur in the operation.

It is particularly advantageous in this arrangement when the cantilever beam has an S-shaped contour. In this manner a certain parallelism of a section closest to the drive and a section closest to the operating element of the mechanical sensing element can be ensured even when there is relatively great pressure application.

The strain sensor is advantageously formed by a strain gauge. This makes it possible to detect at the operating element even very slight compression stresses, as they occur, for example, when simply placing the operating element on the particular foot pedal. On the other hand it is also possible with such a strain gauge to easily detect sharply increasing compression loads as they occur, for example, when an end position of the particular foot pedal is reached. This makes it possible by using the strain gauge as the strain sensor to dispense with other sensors or detecting means, such as for example micro switch devices for detection of the above-mentioned positions.

Additionally it is advantageous when the strain gauge in this arrangement extends over the S-shaped contour region of the mechanical sensing element, which makes it possible to determine by means of the strain gauge even very small force or compressive actions.

Advantageously, the force sensor is connected to an evaluation unit for providing for the transmission of signals. This evaluation unit makes possible a further processing of the measured values determined by the force sensor, for example in order to display these to the user, or in order to use them for controlling the actuator.

Furthermore, it is advantageous when the actuator is controllable by an electronic system, by means of which an operating profile can be stored and executed. This makes it possible to define certain test sequences for a certain type of foot pedals in advance and to store the test sequences using program technology. These tests can then be carried out by means of the actuator apparatus in a recurrent manner on appropriate foot pedals, thereby providing comparable test results.

In another advantageous embodiment the electronic system is connected to the evaluation unit so as to form a control loop. This permits a controlled and therefore particularly precise predefined pressure application to the particular foot pedal via the actuator apparatus.

An illustrative embodiment of the invention is shown in the figures, in which:

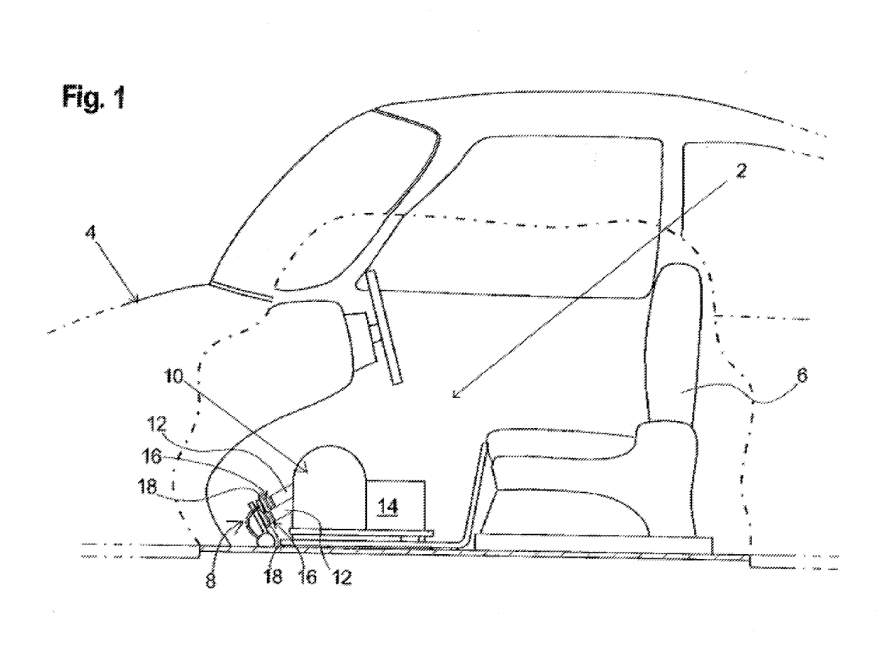

FIG. 1 shows a view of an actuator apparatus according to the invention in the installed state,

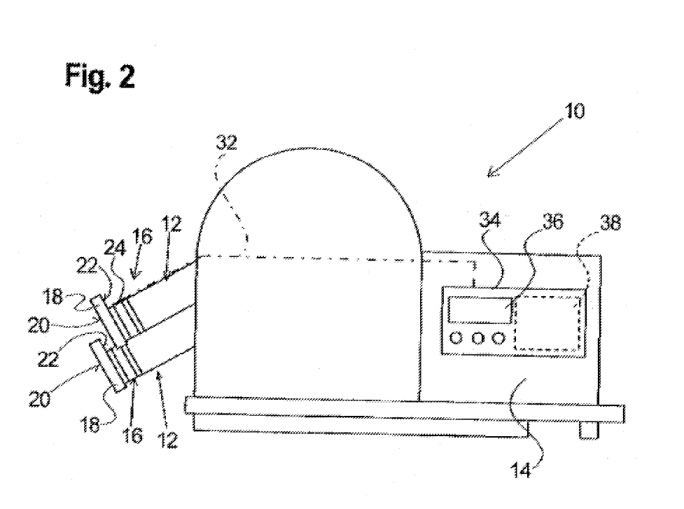

FIG. 2 shows a side view of the actuator apparatus according to FIG. 1, and

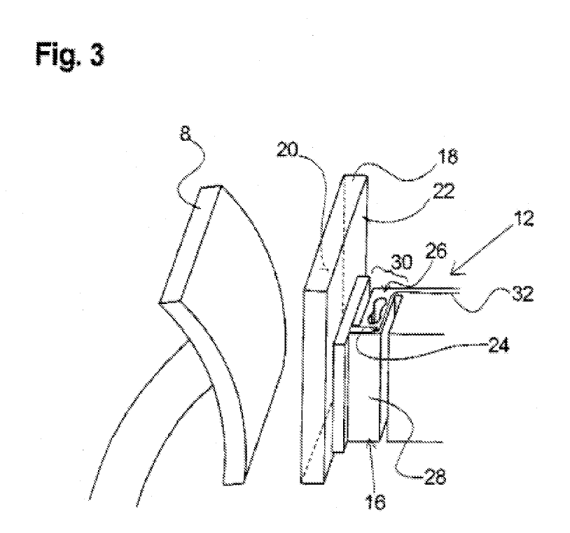

FIG. 3 shows a perspective view of an end closest to the pedal of an operating element of the actuator apparatus according to FIG. 1.

FIG. 1 shows the footwell 2 of a motor vehicle 4 between a driver seat 6 and foot pedals 8. In order to apply pressure to these foot pedals 8 in the course of an endurance test, an actuator apparatus 10 is placed into the footwell 2. This actuator apparatus has, by way of example, two operating elements 12 that can be moved back and forth by means of an actuator 14, in order to recurrently apply a compressive force to the foot pedals 8.

In order to be able to accurately sense the compressive forces generated by the actuator apparatus 10 during pressure application to the foot pedals 8, the operating elements 12 each have a force sensor 16, as can be seen particularly from FIG. 2. This force sensor 16 is provided on a pressure-application plate 18 of the operating element 12, the pressure-application plate having a contact surface 20 for placing same on the foot pedal 8 to which pressure is to be applied. The contact surface 20 is dimensioned in this arrangement such that a reliable contact against the particular foot pedal 8 is ensured in any case under the vibrations that normally occur during operation, but that any pressure application to an adjacent foot pedal 8 can be ruled out on the other hand. The force sensor 16 is provided on a side 22 of the pressure-application plate 18 facing away from the contact surface 20.

As can be seen particularly from FIG. 3, the force sensor 16 has a strain sensor in the form of a strain gauge 24 that is provided on an elastic mechanical sensing element 26. Same is formed by way of example by a cantilever beam 28 having an S-shaped contour 30. The strain gauge 24 in this arrangement extends over a region of the mechanical sensing element 26 that is deformed when a pressure-application force is applied by the operating element 12 onto the foot pedal 8. This deformation is converted by the strain gauge 24 into electrical signals that can be forwarded, for example, via a cable 32.

As can be seen from FIG. 2, the force sensor 16 is connected via the cable 32 or also wirelessly to an evaluation unit 34. Same receives the signals transmitted by the strain gauge 24 according to the pressure-application forces generated at the pressure-application plate 18, converts same according to the characteristic values of the mechanical sensing element 26 into a corresponding active pressure-application force and displays same for example on a display 36.

Additionally an electronic system 38 may be provided, by means of which the actuator 14 is controllable and which includes in particular a memory unit for storing various operating profiles for the actuator 14. This makes it possible to store different predefined test sequences in the form of data and call up the test sequences when needed, in order to trigger the actuator 14 in such a way that the operating element 12 applies pressure to the particular foot pedal 8 using the pres sure-application forces corresponding to the particular operating profile.

Additionally, it is possible to connect this electronic system 38 to the evaluation unit 32, so as to be able, during operation, to continually match a desired value of the pressure-application force as provided by the electronic system 38, to an actual value of the compressive force actually generated at the pressure-application plate 18. In this way the evaluation unit 32 and the electronic system 34 together with the force sensor 16 form a control loop that ensures a direct controlling of the pressure-application forces generated on the foot pedal 8.

1. An actuator apparatus (10) for operation of at least one foot pedal (8) of a motor vehicle (4),
having at least one operating element (12) that is drivable for pressure application to the foot pedal (8) by means of an actuator (14), and
having a force sensor (16), by means of which a pressure-application force that can be generated at a contact surface (20) of the operating element (12) can be detected, characterized in that wherein the contact surface (20) is formed by a pressure-application plate (18) and that the force sensor (16) is disposed on a side (22) of the pressure-application plate (18) facing away from the contact surface (20).

2. The actuator apparatus according to claim 1, wherein the force sensor (16) has a strain sensor on an elastic mechanical sensing element (26) that is disposed between the pressure-application plate (18) and the actuator (14).

3. The actuator apparatus according to claim 2, wherein the mechanical sensing element (26) has a cantilever beam (28).

4. The actuator apparatus according to claim 3, wherein the cantilever beam (28) has an S-shaped contour (30).

5. The actuator apparatus according to claim 2, wherein the strain sensor is formed by a strain gauge (24).

6. The actuator apparatus according to claim 5, wherein the strain gauge (24) extends over the S-shaped contour (30) of the cantilever beam (28).

7. The actuator apparatus according to claim 1, wherein the force sensor (16) is connected to an evaluation unit (34) for providing for the transmission of signals.

8. The actuator apparatus according to claim 1, wherein the actuator (14) is controllable by an electronic system (38), by means of which an operating profile can be stored and executed.

9. The actuator apparatus according to claim 8, wherein the electronic system (38) is connected to the evaluation unit (34) for forming a control loop.
